(19) United States
(12) Patent Application Publication
(10) Pub. No.: US 2025/0330735 A1
(43) Pub. Date: Oct. 23, 2025

(54) ELECTRONIC DEVICE

(71) Applicant: ONKYO CORPORATION, Osaka (JP)

(72) Inventors: Takeshi FUJITANI, Osaka (JP); Norimasa KITAGAWA, Osaka (JP)

(73) Assignee: ONKYO CORPORATION, Osaka (JP)

(21) Appl. No.: 19/172,731

(22) Filed: Apr. 8, 2025

(30) Foreign Application Priority Data
Apr. 19, 2024 (JP) 2024-067859
Apr. 19, 2024 (JP) 2024-067860

(51) Int. Cl. H04R 1/10; H04R 17/00

(52) U.S. Cl. CPC H04R 1/1008; H04R 1/1075; H04R 17/00; H04R 2460/13

(57) ABSTRACT

An electronic device comprising: a first vibration element having a contact surface; and a second vibration element, wherein the first vibration element and the second vibration element are connected in a reverse phase.

### CROSS-REFERENCE TO RELATED APPLICATIONS

This application claims priority to Japanese Application No. 2024-067859, filed Apr. 19, 2024, and No. 2024-067860, filed Apr. 19, 2024 the entire contents of which are incorporated herein by reference.

### FIELD

### The present disclosure relates to an electronic device which includes a vibration source for making a user listen to a sound.

### BACKGROUND

Generally, a sound enters from a hole of an ear, vibrates an eardrum and is conducted to an inner ear (an auditory nerve) and a human listen to the sound. This sound conduction is called an “air conduction” and the sound which is conducted by a vibration of an air is called an “air conduction sound”. In contrast to the “air conduction”, a “bone conduction” directly conducts the sound to the auditory nerve through the vibration of a head bone without the eardrum. An audio acoustic device such as a headphone or an earphone using the bone conduction is different from an audio acoustic device only using the air conduction and can let the ear of a user be open. For example, when the bone conduction is applied to a product which is mainly used outside of a home such as Augmented Reality (AR) glasses, the user can recognize an environmental sound. Therefore, in the product which is mainly used outside of the home, the bone conduction is a preferable sound conduction system. JP 2001-320790 A discloses a glasses-type wearable device using the bone conduction.

As a bone conduction device (a vibration source) for conducting vibration to the head bone, there are an MM system and an MC system dynamic type excitors and a piezoelectric element. In the former dynamic type excitor, weight and size are large. Therefore, in a wearable product that light weight is demanded such as the AR glasses, the latter piezoelectric element is preferable including wearability.

However, in the glasses-type wearable device using the piezoelectric element, when the piezoelectric element is incorporated in a temple, vibration from the piezoelectric element is conducted to the temple and sound leakage occurs. Therefore, there is a problem that it is difficult for a user to use it in a public place such as a train or a bus.

Further, generally, in the glasses-type wearable devices using the bone conduction devices, there are a type which vibrates a side of a tragus and a type which vibrates a back of an auricle. In these types of wearable devices, when the devices do not have an adjustable mechanism for fitting the bone conduction device to a user's head, the bone conduction devices do not fit to the heads of many users and the sound listening level of the users decrease.

As described above, JP 2001-320790 A discloses the glasses-type wearable device using the bone conduction device and this wearable device includes a mechanism for adjusting a position of the bone conduction device. However, as illustrated in FIG. 3 of JP 2001-320790 A, since a spindle of the adjustable mechanism is positioned behind the auricle, the bone conduction device cannot be fitted to the user.

As described above, the conventional glasses-type wearable device using the bone conduction device (for example, the piezoelectric element) has the sound leakage problem.

Further, as described above, the conventional glasses-type wearable device using the bone conduction device has the problem that the user cannot listen to the sound with sufficient sound volume.

### SUMMARY OF THE INVENTION

According to one aspect of the disclosure, there is provided an electronic device comprising: a first vibration element having a contact surface; and a second vibration element, wherein the first vibration element and the second vibration element are connected in a reverse phase.

Further, according to one aspect of the disclosure, there is provided an electronic device comprising: a first enclosure which contacts a root of an ear in a wearing state; a vibration source; a second enclosure which holds the vibration source; and a connection part which rotatably connects the first enclosure and the second enclosure, wherein the connection part rotates the vibration source from a first position to a second position which is a using position and from the second position to the first position, and the second position is positioned at an inner side than the first position in the wearing state.

### BRIEF DESCRIPTION OF THE DRAWINGS

FIG. 1 is a perspective diagram illustrating a wearable device according to the embodiment.

FIG. 2 is a perspective diagram illustrating the wearable device according to the embodiment.

FIG. 3 is a diagram illustrating the wearable device which is worn by a user.

FIG. 4 is an enlarged sectional diagram of a broken line part B in FIG. 1.

FIG. 5 is a diagram for explaining a measuring position.

FIG. 6 (a) is a graph illustrating a measuring result of sound leakage when wearing the wearable device.

FIG. 6 (b) is a diagram illustrating a measuring result of sound leakage in overall level.

### DETAILED DESCRIPTION OF THE PREFERRED EMBODIMENTS

An objective of the present disclosure is to prevent sound leakage.

Further, an objective of the present disclosure is to make a user listen to a sound with sufficient sound volume.

The embodiment is described below. Hereinafter, the embodiment in which an electronic device including a vibration source for making a user listen to a sound is applied to a glasses-type wearable device is described.

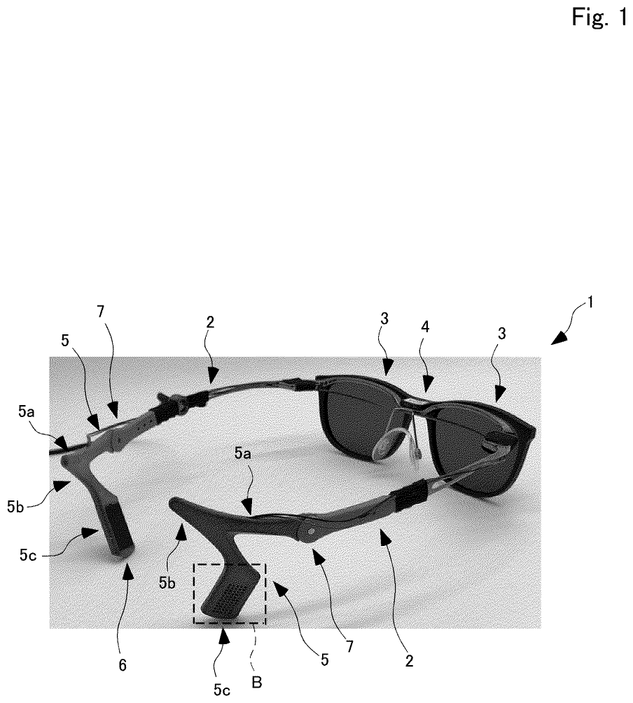

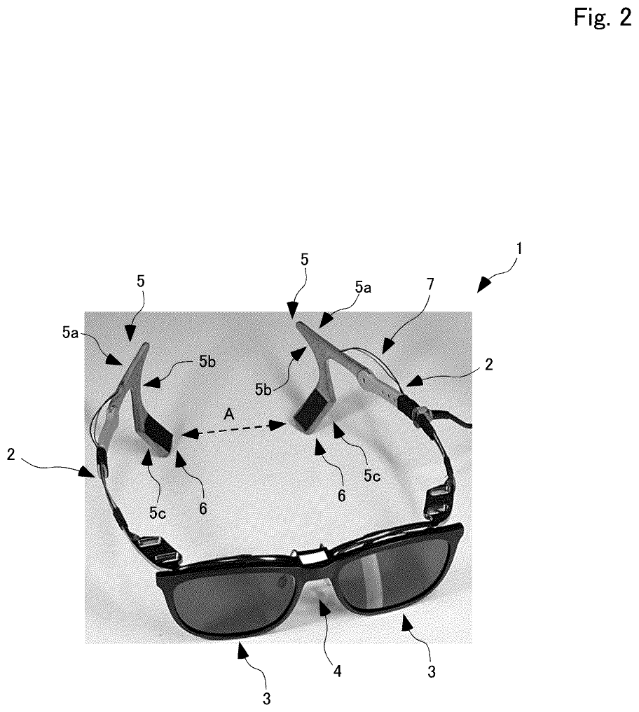

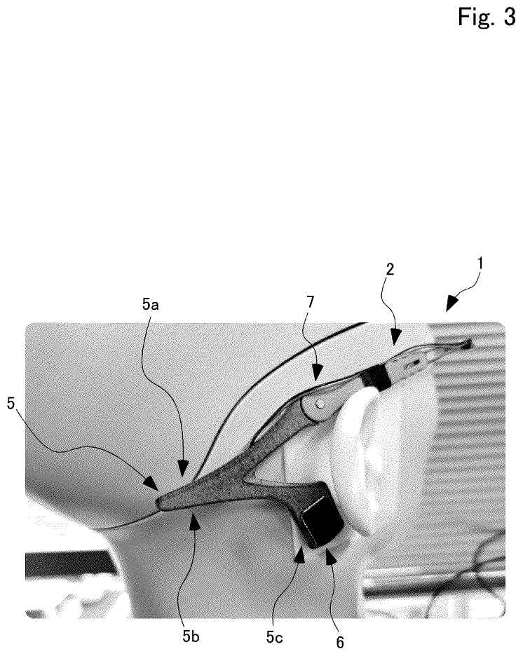

Each of FIG. 1 and FIG. 2 is a perspective diagram illustrating a wearable device 1 according to the embodiment. FIG. 3 is a diagram illustrating the wearable device 1 which is worn by a user. As illustrated, the wearable device 1 includes temples 2, rims 3, a bridge 4 and temple tips 5. The rim 3 is a part which forms a inside space for holding a lens or a projection part in case of an AR glasses. Two rims 3 are provided corresponding to user's eyes. The two rims 3 are connected to each other by the bridge 4.

The temple 2 (a first enclosure) is a part which extends vertically against an arrangement direction of the two rims 3. The temple 2 and the rim 3 are connected by a hinge. Each of the two temples 2 can rotate by means of the hinge from a state which is illustrated in FIG. 1 and FIG. 2 to the inside against each of the two rims 3. As illustrated in FIG. 3, the temple 2 contacts a root of an ear of the user in a state (a wearing state) that the wearable device 1 is worn by the user. The temple tip 5 (a second enclosure) is a part which is put on the ear of the user in the wearing state. The temple tip 5 is a tip part of the temple 2.

The wearable device 1 further includes vibration sources 6 and connection parts 7. The vibration source 6 is a vibration source for making the user listen to the sound. The vibration source 6 is described below.

The connection part 7 connects the temple 2 and the temple tip 5 rotatably. The connection part 7 consists of a rotation mechanism which can change an angle of the temple 2 and the temple tip 5. The connection part 7 is positioned on a straight line of the temple 2 and at the tip of the temple 2. The connection part 7 is positioned behind the root of the ear in the wearing state (a state illustrated in FIG. 3). Further, as illustrated in FIG. 3, the connection part 7 is positioned above an auricle in the waring state. The connection part 7 makes the vibration source 6 (the temple tip 5) rotate from a first position (a position which is illustrated in FIG. 1 and FIG. 2) to a second position which is a position in a using state (a position which is illustrated in FIG. 3). Further, the connection part 7 makes the vibration source 6 (the temple tip 5) rotate from the second position to the first position.

Herein, the second position is positioned at an inner side of the ear than the first position in the wearing state. In other words, a distance (a distance of a broken line A) between the two vibration sources 6 (the temple tips 2) in the second position is shorter than the distance between the two vibration sources 6 (the temple tips 5) in the first position. Further, the first position is positioned at an outer side of the ear than the second position in the wearing state, In other words, the distance (the distance of the broken line A) between the two vibration sources 6 (the temple tips 5) in the first position is longer than the distance between the two vibration sources 6 (the temple tips 5) in the second position. A curvature of the temple tip 5 is set so as to be such a positional relation of the first position and the second position.

By the above described positional relation of the first position and the second position, a lateral pressure becomes large when the vibration source 6 (the temple tip 5) moves from the first position to the second position and the lateral pressure is released when the vibration source 6 (the temple tip 5) moves from the second position to the first position.

As illustrated, the temple tip 5 consists of a first part 5a which extends from an end part of the temple 2 to a rear direction of the ear, a second part 5b which bends from an end part of the first part 5a to a lower and a front direction of the ear, and a third part 5c which bends from an end part of the second part 5b to a lower and a rear direction of the ear.

In the above described glasses (sunglasses) type wearable device 1, by the connection part 7 which can adjust an angle of the temple 2 and the temple tip 5, the user can adjust a position of a piezoelectric element 5 which is positioned behind the auricle in the wearing state to the user of the wearable device 1. Further, a spindle of the connection part 7 is arranged above the auricle. An interval of the temple tips 5 on which the piezoelectric elements 6 are provided becomes narrower when the temple tips 5 are rotated from the first position to the second position (the temple tips 5 are rotated to a front direction to wear the wearable device 1) and the interval becomes larger when the temple tips 5 are rotated from the second position to the first position (the temple tips 5 are rotated to a rear direction to take the wearable device 1 off).

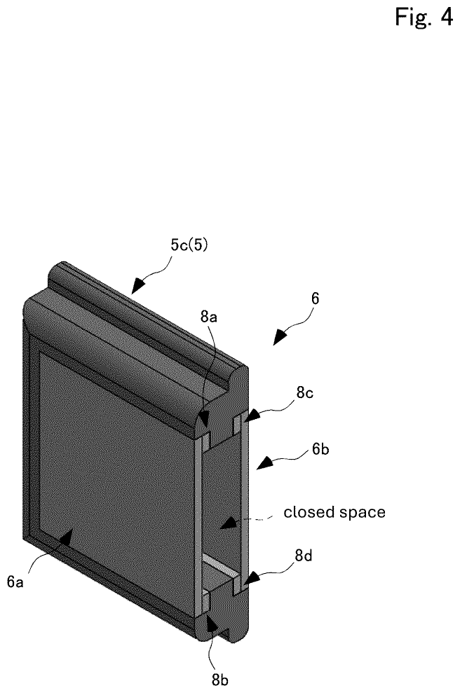

FIG. 4 is an enlarged sectional diagram of a broken line part B in FIG. 1. FIG. 4 illustrates a cross section of a direction which is orthogonal to a longitudinal direction of the piezoelectric elements 6a and 6b described below. The vibration source 6 is mounted on the third part 5c of the temple tip 5. Namely, the temple tip 5 holds the vibration source 6. The vibration source 6 consists of the two piezoelectric elements 6a and 6b (vibration elements). The piezoelectric elements 6a and 6b are connected in a reverse phase.

Each of the piezoelectric elements 6a and 6b is a flat and substantially cuboid shape. Namely, each of the piezoelectric elements 6a and 6b is a rectangular flat board. For example, a size of a maximum surface of each of the piezoelectric elements 6a and 6b is 20 mm×10 mm. Each of the piezoelectric elements 6a and 6b is a laminated piezoelectric element.

The piezoelectric elements 6a and 6b are arranged so that the maximum surfaces are opposed each other. For example, a distance between the piezoelectric element 6a and the piezoelectric element 6b which are opposed to each other is 1 mm. It is preferable that the piezoelectric element 6a and the piezoelectric element 6b are arranged as close as possible (in close proximity) to each other without contact. A side of opposed surfaces of the piezoelectric elements 6a and 6b is sealed. A surface which is opposite to the opposed surfaces of the piezoelectric elements 6a and 6b is open.

The piezoelectric element 6a is mounted on the temple tip 5 via elastic members 8a and 8b. Each of the elastic members 8a and 8b extends along a longitudinal direction of the piezoelectric element 6a. The elastic members 8a and 8b are arranged along the longitudinal direction in both ends of a short direction of the piezoelectric element 6a. The piezoelectric element 6b is mounted on the temple tip 5 via elastic members 8c and 8d. Each of the elastic members 8c and 8d extends along a longitudinal direction of the piezoelectric element 6b. The elastic members 8c and 8d are arranged along the longitudinal direction in both ends of a short direction of the piezoelectric element 6b. It is preferable that material of each of the elastic members 8a to 8d is an elastomer, a silicone rubber, a chloroprene rubber, a urethane rubber, a butadiene rubber or the like. It is preferable that a hardness of each of elastic members 8a to 8d is 30 to 50 degrees.

As illustrated in FIG. 3, an open surface (the maximum surface) of one piezoelectric element 6b abuts on (contacts) a bone part such as a head part of the user. An elastomer sheet or the like may be affixed to the open surface of the one piezoelectric element 6b for protection. Further, a punching metal, a mesh metal or the like may be provided at an open surface of the other piezoelectric element 6a for protection.

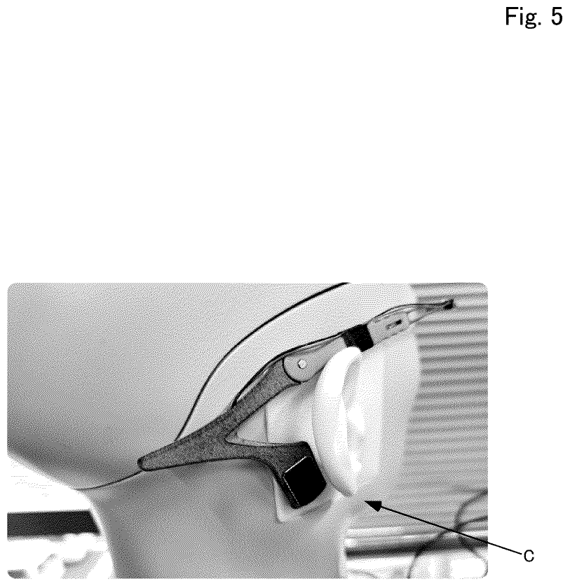

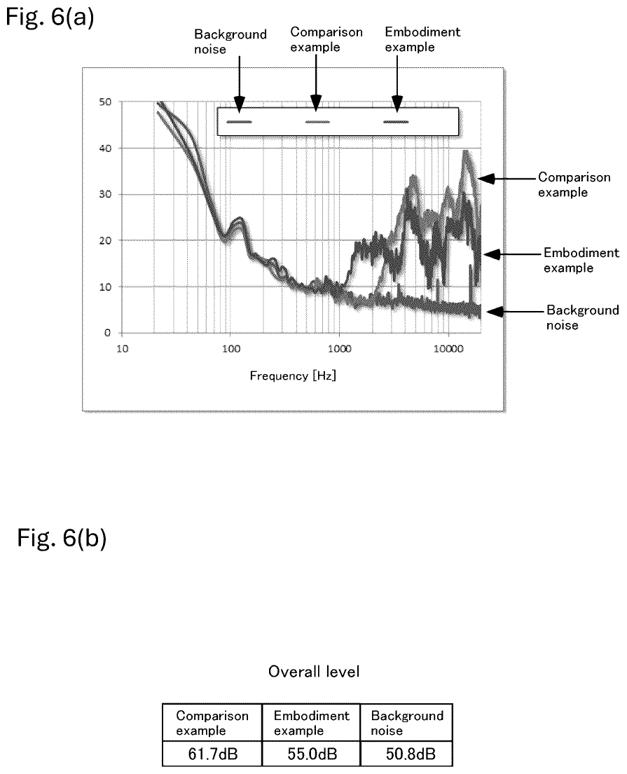

A measuring result of sound leakage when wearing the wearable device 1 is described below. FIG. 6(a) is a graph illustrating the measuring result of the sound leakage when wearing the wearable device 1. FIG. 6(b) is a diagram illustrating the measuring result of the sound leakage at an overall level. As an embodiment example, the wearable device 1 according to the embodiment is used. As a comparison example, a device that the vibration source 6 of the wearable device 1 is changed to a piezoelectric element and both sides of the piezoelectric element are fully opened is used. An arrow C of FIG. 5 illustrates a measuring position. As the other measuring conditions, a microphone distance is 5 cm and an output signal is a white noise. A sound leakage characteristic illustrated in FIG. 6 is measured when the device is worn on a human body (skin tissue).

In the embodiment example, although a sound leakage level around 1.5 k to 2 kHz becomes high, the levels thereafter are lowered. Further, in an overall level value, the embodiment example is lower than the comparison example by 6.7 dB and it is understood that the sound leakage is suppressed. It is thought that a vibration from the vibration source 6 to an enclosure including the temples 5 is canceled.

As described above, in the embodiment, the connection part 7 rotates the vibration source 6 from the first position to the second position which is a position of the using state. Herein, the second position is positioned at an inner side of the ear than the first position in the waring state. Thus, since the vibration source 6 which moves to the inside of the ear can contact the user, it is possible to make the user listen to the sound with sufficient sound volume. Further, the sound leakage can be prevented.

Further, in the embodiment, the connection part 7 is positioned above the auricle in the wearing state. Thus, since it is possible to make a moving range of the vibration source 6 large, the vibration source 6 can contact an appropriate place of the user.

Further, in the embodiment, the wearable device 1 is a glasses-type wearable device. Further, the connection part 7 rotates the vibration source 6 from the first position to the second position and from the second position to the first position. Herein, a distance between the two vibration sources 6 at the second position is narrower than a distance between the two vibration sources 6 at the first position. Thus, the user moves (rotates) the vibration source 6 from the first position to the second position and can easily wear the glasses-type wearable device 1.

Further, the distance between the two vibration sources 6 at the first position is wider than the distance between the two vibration sources 6 at the second position. Thus, the user moves (rotates) the vibration source 6 from the second position to the first position to easily take the glasses-type wearable device 1 off.

Further, in the embodiment, the maximum surfaces of the flat and substantially cuboid shape piezoelectric elements 6a and 6b are the contact surfaces. Namely, the maximum surfaces of the piezoelectric elements 6a and 6b contact the user. Thus, the user can listen to the sound with sufficient sound volume.

Further, in the embodiment, the vibration source 6 is held by the temple tip 5 via the elastic member 8. Thus, it is prevented that the vibration of the vibration source 6 is conducted to the temple tip 5 and the sound leakage is prevented.

Further, in the embodiment, the connection part 7 consists of a rotation mechanism which can change an angle of the temple 2 and the temple tip 5. Thus, the user can easily fix the vibration source 6 at a desired position.

Further, in the embodiment, the two piezoelectric elements 6a and 6b are connected in the reverse phase. With this configuration, sound from each piezoelectric element is cancelled out, thus preventing sound leakage.

The embodiment is described above, but the mode to which the present disclosure is applicable is not limited to the above embodiment and can be suitably varied without departing from the scope of the present disclosure.

In the above described embodiment, as an electronic device to which the present disclosure is applied, the glasses-type wearable device 1 is illustrated. Not limited to this, if the electronic device is an electronic device which includes a vibration element such as a piezoelectric element which is a vibration source for making a user listen to sound, the other electronic device may be applied.

In the above described embodiment, as the vibration element which is the vibration source for making the user listen to the sound, the piezoelectric element is illustrated. Not limited to this, the other vibration element may be applied.

The present disclosure can be suitably employed in the electronic device which includes the vibration source which makes the user listen to the sound.

What is claimed is:

1. An electronic device comprising:
a first vibration element having a contact surface; and
a second vibration element,
wherein the first vibration element and the second vibration element are connected in a reverse phase.

2. The electronic device according to claim 1,
wherein the first vibration element and the second vibration element are arranged opposed to each other,
an opposed surface side of the first vibration element and the second vibration element is sealed, and
a surface which is opposite to the opposed surface of the first vibration element and the second vibration element is open.

3. The electronic device according to claim 1,
wherein each of the first vibration element and the second vibration element is a flat and substantially cuboid shape, and
a maximum surface of the first vibration element is a contact surface.

4. The electronic device according to claim 1,
wherein the first vibration element and the second vibration element are arranged in close proximity and opposed to each other.

5. The electronic device according to claim 1, further comprising:
a first enclosure configured to contact a root of an ear in a wearing state;
a vibration source having the first vibration element and the second vibration element;
a second enclosure configured to hold the vibration source; and
a connection part configured to rotatably connect the first enclosure and the second enclosure.

6. The electronic device according to claim 5,
wherein the connection part rotates the vibration source from a first position to a second position which is a position in a using state and from the second position to the first position, and
the second position is an inner side of an ear in a wearing state than the first position.

7. The electronic device according to claim 5,
wherein the connection part is positioned above an auricle.

8. The electronic device according to claim 5, further comprising:
the two first enclosures;
the two vibration sources;
the two second enclosure; and
the two connection parts,
wherein a distance between the two vibration sources at the second position is narrower than a distance between the two vibration sources at the first position.

9. The electronic device according to claim 8,
wherein the distance between the two vibration sources at the first position is wider than the distance between the two vibration sources at the second position.

10. The electronic device according to claim 9,
wherein each of the two first enclosures is a temple,
the electronic device further comprising:
two rims which are respectively connected to the two temples; and
a bridge which connects the two rims, and
the electronic device is a glasses-type.

11. The electronic device according to claim 1,
wherein each of the first vibration element and the second vibration element is a piezoelectric element.

12. The electronic device according to claim 5,
wherein the vibration source is held by the second enclosure via an elastic member.

13. The electronic device according to claim 5,
wherein the connection part consists of a rotation mechanism which can change an angle of the first enclosure and the second enclosure.

14. An electronic device comprising:
a first enclosure which contacts a root of an ear in a wearing state;
a vibration source;
a second enclosure which holds the vibration source; and
a connection part which rotatably connects the first enclosure and the second enclosure,
wherein the connection part rotates the vibration source from a first position to a second position which is a using position and from the second position to the first position, and
the second position is positioned at an inner side than the first position in the wearing state.
